(19) United States
(12) Patent Application Publication
(10) Pub. No.: US 2017/0068992 A1
(43) Pub. Date: Mar. 9, 2017

(54) MULTI-SOURCE CONTENT BLENDING

(71) Applicant: Yahoo! Inc., Sunnyvale, CA (US)

(72) Inventors: Kehan Chen, Beijing (CN); Jian Xu, San Jose, CA (US); Yu Zou, Beijing (CN)

(21) Appl. No.: 14/846,618

(22) Filed: Sep. 4, 2015

(51) Int. Cl. G06Q 30/02; H04L 29/06; H04L 29/08

(52) U.S. Cl. CPC G06Q 30/0269; H04L 67/22; H04L 65/4069

(57) ABSTRACT

A method and apparatus for multi-source content blending.

### FIELD

The subject matter disclosed herein relates generally to multi-source content blending.

### BACKGROUND

Some existing websites and/or web portals provide a stream of content items. However, streams of content typically may not be customized for an individual user. Instead, a stream of content provided to one user may be identical to a stream of content provided to a different user with different interests and/or preferences. Similarly, advertising may be inserted into a stream of content in static slots without taking into account, for example, user preferences and/or interests.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be best understood by reference to the following detailed description if read with the accompanying drawings in which:

FIG. 1A is an illustration of a stream of content items according to one embodiment.

FIG. 1B is a block diagram illustrating an embodiment of an architecture for forming a stream of content.

FIG. 2 is a flow chart illustrating an embodiment of a method of forming a blended stream of content.

FIG. 3 is block diagram illustrating an embodiment of an architecture for blending content.

FIG. 4 is a plot illustrating changes in user engagement versus advertising click percentage for an example embodiment.

FIG. 5 is a block diagram illustrating an embodiment of a system for blending content.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which apportions of a computational problem may be allocated among computing devices, including one or more clients and one or more servers, via a computing and/or communications network, for example.

A network may comprise two or more network devices and/or may couple network devices so that signal communications, such as in the form of signal packets and/or frames, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be compliant and/or compatible with differing protocols, such as computing and/or communication protocols (e.g., network protocols), may interoperate within a larger network. In this context, the term sub-network refers to a portion and/or part of a network. Sub-networks may also comprise links, such as physical links, connecting and/or coupling nodes to transmit signal packets and/or frames between devices of particular nodes including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting network communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but such devices outside the private network may not necessarily direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known and/or later developed. The Internet includes local area networks (LANs), wide area networks (WANs), wireless networks, and/or long haul public networks that, for example, may allow signal packets and/or frames to be communicated between LANs. The term world wide web (WWW or web) and/or similar terms may also be used, although it refers to a sub-portion of the Internet that complies with the Hypertext Transfer Protocol or HTTP. For example, network devices may engage in an HTTP session through an exchange of Internet signal packets and/or frames. It is noted that there are several versions of the Hypertext Transfer Protocol. Here, the term Hypertext Transfer Protocol or HTTP is intended to refer to any version, now known and/or later developed. It is likewise noted that in various places in this document substitution of the term Internet with the term World Wide Web may be made without a significant departure in meaning and may, therefore, not be inappropriate in that the statement would remain correct with such a substitution.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The Internet has evolved to a public, self-sustaining facility that may be accessible to tens of millions of people or more worldwide. Also, in an embodiment, and as mentioned above, the terms “WWW” and/or “web” refer to a sub-portion of the Internet that complies with the Hypertext Transfer Protocol or HTTP. The web, therefore, in this context, may comprise an Internet service that organizes stored content, such as, for example, text, images, video, etc., through the use of hypermedia, for example. A HyperText Markup Language (“HTML”), for example, may be utilized to specify content and/or format of hypermedia type content, such as in the form of a file or an “electronic document,” such as a web page, for example. An Extensible Markup Language (“XML”) may also be utilized to specify content and/or format of hypermedia type content, such as in the form of a file or an “electronic document,” such as a web page, in an embodiment. Of course, HTML and XML are merely example languages provided as illustrations and, furthermore, HTML and/or XML is intended to refer to any version, now known and/or later developed. Likewise, claimed subject matter is not intended to be limited to examples provided as illustrations, of course.

The term “website” and/or similar terms refer to a collection of related web pages, in an embodiment. The term “web page” and/or similar terms relates to any electronic file and/or electronic document, such as may be accessible via a network, by specifying a uniform resource locator (URL) for accessibility via the web, in an example embodiment. As alluded to above, a web page may comprise content coded using one or more languages, such as, for example, HTML and/or XML, in one or more embodiments. Although claimed subject matter is not limited in scope in this respect. Also, in one or more embodiments, developers may write code in the form of JavaScript, for example, to provide content to populate one or more templates, such as for an application. Here, JavaScript is intended to refer to any now known or future versions. However, JavaScript is merely an example programming language. As was mentioned, claimed subject matter is not limited to examples or illustrations.

Terms including “entry”, “electronic entry”, “document”, “electronic document”, “content”, “digital content”, “item”, and/or similar terms are meant to refer to signals and/or states in a format, such as a digital format, that is perceivable by a user, such as if displayed and/or otherwise played by a device, such as a digital device, including, for example, a computing device. In an embodiment, “content” may comprise one or more signals and/or states to represent physical measurements generated by sensors, for example. For one or more embodiments, an electronic document may comprise a web page coded in a markup language, such as, for example, HTML (hypertext markup language). In another embodiment, an electronic document may comprise a portion and/or a region of a web page. However, claimed subject matter is not limited in these respects. Also, for one or more embodiments, an electronic document and/or electronic entry may comprise a number of components. Components in one or more embodiments may comprise text, for example as may be displayed on a web page. Also for one or more embodiments, components may comprise a graphical object, such as, for example, an image, such as a digital image, and/or sub-objects, such as attributes thereof. In an embodiment, digital content may comprise, for example, digital images, digital audio, digital video, and/or other types of electronic documents.

Signal packets and/or frames, also referred to as signal packet transmissions and/or signal frame transmissions, and may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path comprising a portion of the Internet, from a site via an access node coupled to the Internet. Likewise, a signal packet and/or frame may be forwarded via network nodes to a target site coupled to a local network, for example. A signal packet and/or frame communicated via the Internet, for example, may be routed via a path comprising one or more gateways, servers, etc. that may, for example, route a signal packet and/or frame in accordance with a target and/or destination address and availability of a network path of network nodes to the target and/or destination address. Although the Internet comprises a network of interoperable networks, not all of those interoperable networks are necessarily available and/or accessible to the public. A network may be very large, such as comprising thousands of nodes, millions of nodes, billions of nodes, or more, as examples.

Selection of content items to display to a user, such as by a website on the Internet, presents a number of challenges. Although not limited to the Internet (e.g., any network), one objective of websites that provide content items, such as for display on client devices, may include maintaining user interest and/or user views of content items so as to, among other things, gain advertising-related revenue and/or provide users a positive experience. As such, maintaining engagement and/or interest of users by determining which content items to provide, which content sources to consult, which topics of content items to provide, how to order selected content items, etc., can be challenging at least because considerations, such as user interests and/or preferences, may not necessarily be known and/or capable of being reliably ascertained, such as by a website.

To illustrate, again, for any network, but using the Internet as example, content items may be displayed to users via the Internet in a number of possible ways. Some websites may provide a plurality of links to content items. Some example websites that provide content items, such as displayed by a client browser, are referred to as web portals, and/or may provide content items from a variety of sources. The Yahoo! homepage comprises an example of a web portal. Websites, such as web portals, may offer a list of trending and/or popular content items and/or content topics, among other things. Sample content items may include, by way of illustration, but not limitation, news articles, opinion pieces, advertisements, slideshows, videos, etc. Some websites, such as web portals, may provide advertising-related content items, as well as non-advertising-related content items. On websites, such as these, then, there may be a desire to maintain a user's interest in content items provided via a webpage so as to increase a probability that an advertising-related content item may be selected, for example, by a user viewing on a client device.

Some websites may provide content items limited to a type, source, topic, or a combination thereof. For examples, some websites may offer video content (e.g., YouTube), and some websites may offer content on one or more particular topics (e.g., ESPN.com, which provides content items about sports). Nevertheless, there still may be a desire to determine relevant (e.g., potentially of interest to a user) content items to provide, including advertisements, such as to maintain or increase user interest in a webpage.

In contrast to the foregoing example websites, search engines provide content items and/or links to content items that may be displayed by a client device in response to a user query, which may provide indications of user interests and/or preferences. For at least that reason (e.g., an absence of a query), methods and/or approaches for determining relevant content items for search engines may be less desirable and/or less effective in general for use in determining content recommendations for websites, such as web portals.

Typically, to display one or more content items on a client device, a remote device, such as a server, may transmit one or more signals and/or states to the client device to enable the client device to display the one or more content items. In this example, a user may interact with an input device of the client device to manipulate and/or interact with one or more portions of content, such as might be provided at least in accordance with the one or more signals and/or states received from a remote device (e.g., a server), and displayed on the client, such as via a client browser, as an example. In one approach to displaying content items, a list of content items, such as displayed by a client device, may comprise a limited number of content items, and as users reach an end of the list of content items that are displayed (e.g., provided from a website and displayed on a client device, for example), it may be possible to view additional content items by interacting with an element or component also provided from the website (e.g., a button for “MORE” content items, etc.). However, as users reach an end of a list of content items, there may be a tendency to navigate away from a webpage rather than interacting with an interactive element or component to retrieve additional content. As such, approaches to providing content in the form of a limited list of content items (e.g., calling for user interaction with elements or components at the client device to access additional content items) may be less effective and/or less desirable for encouraging users to remain on a webpage.

Recently, however, some websites have begun adopting an approach for providing content items whereby a stream of content items is provided for which there may appear on the client device to be no end (e.g., a stream of content items that does not appear to be limited to a small number of content items). As such, in one implementation, a user may be able to scroll through a seemingly limitless number of content items. For example, as opposed to clicking on a button or a link to view additional content items, in some cases, a seemingly limitless number of additional content items may be provided in a stream of content (e.g., provided from a website and loaded as appropriate by a client device) so as to simulate a continuous or continual stream of content, such as, for example, but without limitation, as a user scrolls through a list of content items. As used herein, any user interaction with an input device (e.g., a keyboard, mouse, or touch screen) of a computing device, such as scrolling, may be used to result in movement on a display of a portion of displayed or to be displayed content (such as provided from a website), such as to reveal content items that may not be otherwise visible on a display of a computing device and/or to reposition a content item on a display of a computing device. For example, user interaction, such as scrolling, may result in horizontal and/or vertical movement of a portion of to be displayed content, such as for a website and/or an element of a website.

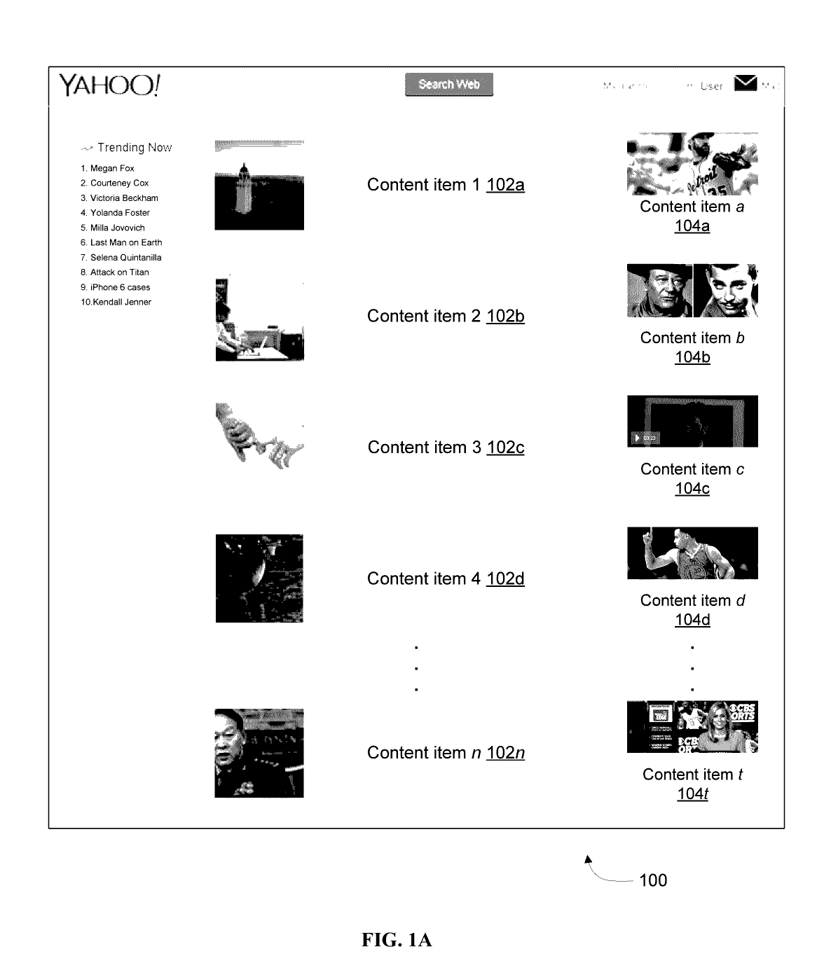

Referring to FIG. 1A, an example stream of content items is illustrated. Content items 1-n (102a-102n) comprise a number of example content items, such as to be “clicked” by a user. For instance, content items 102a-102n may comprise content items of one or more content sources, content types, and/or content topics. FIG. 1A also illustrates that some embodiments may provide content items for display in other positions while being from a stream of content such as, for example, content items a-t (104a-104t). These example content items may, in one embodiment, comprise a number of content items of different content types, content sources, and/or content topics.

As noted above, challenges in forming continuous or continual streams of content to be provided while also encouraging users to remain, such as on a website, include determining which content items to select from a plurality of content sources, which content items to select from a plurality of content types, which content items to select of a plurality of content topics, and/or where to place content items within a stream of content, among other things. For example, some users may have preferences towards certain content types, where content types in this context refers to a source of content candidates of a common kind, class, group, etc., and/or obtained via a common retrieval method. For example, in-network contents (e.g., content items from a common website or web portal), off-network contents (e.g., content items from external third party providers), advertising content items, news articles, slideshows, videos, etc. comprise examples of content types. Some users may have preferences towards certain content sources, where content sources refer to an origin and/or source of content items. For example, in one embodiment, a stream of content may comprise content items that originate from a traditional source of news and/or current events (e.g., CNN, the Wall Street Journal, New York Times, etc.), from non-traditional news sources (e.g., Buzzfeed, Engadget, TMZ, etc.), from social media (e.g., Twitter, Reddit, etc.), etc. Additionally, some users may have preferences towards certain content topics, where content topics refer to a topic and/or theme of content items. For example, celebrity gossip, sports (e.g., news regarding a particular sport, athlete, coach, team, league, etc.), business, money, politics, etc.

Therefore, there may be a desire to provide content items in a stream of content that takes user preferences, whether explicit, implicit, or otherwise estimated, into account so as to, among other things, encourage users to remain, such as on a website and/or view content items provided by a website.

Referring to FIG. 1B, a stream of content that does not take user preferences into account may be formed by a system 110 that may comprise one or more remote devices, such as to engage a user at a website front end 112. In one illustrative example, front end 112 may receive one or more characteristics related to a user, a user's device, a user's preferences, etc., such as if a client device connects with a remote device that may host front end 112. Received characteristics, such as from a client device, may be communicated, such as to a collection component 124, which may store one or more characteristics in a computer readable medium, such as user profile component 122. However, system 110 may not take user preferences into consideration if selecting content items, such as from repositories 120, to provide to users, such as to be displayed via a client device. Instead, a content feeder 118 may, for example, arbitrarily select one or more content items from one or more repositories 120 (e.g., for storing one or more content items of one or more content types) to provide.

To measure user interest and/or satisfaction, such as with a webpage, comprising, for example, interest in one or more content items of a stream of content, it may be desirable to have one or more indications of user interest and/or satisfaction. Thus, for example, one factor that may indicate potential user interest and/or satisfaction, for example, in a website and/or stream of content, may comprise user engagement, which refers to a degree to which a user is interested in, views, and/or otherwise interacts with content items, such as provided by a website. In one implementation, user engagement may also correspond to profitability or monetizability of a website and/or stream of content items. In one approach, user engagement may be measured comprising, for example, a length of time that a user remains on a website and/or interacts with a stream of content items, a number of content items selected by a user, a number of times in a period of time in which a user visits a website comprising a stream of content, etc. Therefore, there may be a desire to form a stream of content items in such a way as to maintain or increase user engagement. Claimed subject matter includes an approach for forming a stream of content while maintaining or increasing user engagement based at least in part on estimates of one or more preferences of content type, source, and/or topic for a user or a group of users, as described in more detail.

For instance, certain users may prefer video content, and, in one embodiment, a number of content items of a video content type may be provided at greater frequencies for users with preferences for video-type content items. By way of further example, some users may prefer content items related to celebrity gossip rather than current events. And in one embodiment, content streams formed for such users may have a greater ratio of content items from content sources that provide celebrity gossip and/or content items of a celebrity gossip topic rather than content items of content sources and/or topics related to current events, such as in any particular portion of a provided content stream.

While previous approaches may have formed non-customized or non-personalized content streams, such as for users that access a webpage (e.g., a webpage comprising front end 112), claimed subject matter includes an approach whereby browsing behavior may be used at least in part to form a personalized or customized content stream, to be provided, for example. Estimations as to user preferences and/or interests may be based at least in part on records indicating browsing behavior. In one embodiment, indications of browsing behavior may be gathered as users interact with links, content items, visit webpages, etc. For example, as illustrated in FIG. 1B, indications of browsing behavior may be collected from users, such as by a collection component 124, and stored in a repository or storage medium, such as illustrated by user profile 122. For convenience, stored signals and/or states that comprise indications of browsing behavior are referred to herein as logs of browsing behavior.

At times, there may be a sufficient quantity of indications of browsing behavior to infer (or indications of browsing behavior may include express preferences) user preferences and/or interests across multiple content types, sources, and/or topics. In such cases, it may be possible to form a stream of content by blending content items of multiple content types, sources, and/or topics, based, at least in part, on available indications of browsing behavior, such as may be stored for a user and/or group of users, such as in a log of browsing behavior. In other cases, however, indications of browsing behavior may be sparse for one or more users. For example, for a particular user, a log of browsing behavior may not comprise indications of browsing behavior as to one or more content types, one or more content sources, and/or one or more content topics. In the absence, be it complete or partial, of indications of browsing behavior, probability and/or statistics may be used, in conjunction with available indications of browsing behavior, to estimate a likelihood that one or more content items may be selected, such as based at least in part on a user's browsing behavior and/or browsing behavior of other users.

One approach for deriving an estimate of user preferences and/or interests may comprise employing assumptions and/or simplifications as to browsing behavior and/or relationships between browsing behavior and user preferences and/or interests, among other things. In one embodiment, estimates of preferences substantially in accordance with simplifications and/or assumptions may be used at least in part to estimate a measure of likelihood of selection of content items for a user (e.g., click propensity). In one embodiment, this likelihood is intended to reflect an estimated probability that a particular user will select a particular content item (e.g., a prediction, which, as used herein, refers to an estimate). For example, a likelihood of selection may be determined for a plurality of content items, content types, content sources, and/or content topics, and used, at least in part, in forming a stream of content items. In one embodiment, a likelihood of selection of a content item may also take into account a position of a content item in a stream of content. As used herein, a likelihood (or estimates thereof) that a user and/or group of users will select a content item is referred to as a click propensity (as previously suggested) and may be calculated for one or more content items, one or more content types, one or more content sources, and/or one or more content topics.

Click propensity may be used in conjunction with a pool of content items, content types, content sources, and/or content topics, to determine content items of a given type, source, and/or topic to be inserted into a stream of content, such as to at least maintain user engagement (e.g., even increase). For example, estimates of click propensity yield quantifiers that may be usable to derive one or more ratios of content types, origins, and/or topics to a total number of content items in a portion of a stream of content items to thereby determine content items, content types, content sources, and/or content topics (e.g., estimates thereof) for a stream to be formed.

In one embodiment, a ratio of content items of a first content type to content items of a second content type in a stream of content may also be determined based, at least in part, on a click propensity. To illustrate with a simplified example, if it is assumed that a click propensity determination reveals that, for a given user, two content types likely to be selected include content items comprising political opinion pieces and cat picture slideshows, where a click propensity for the political opinion pieces is approximately twice that of the cat picture slideshows, then a number of content items comprising political opinion pieces may be approximately twice that of content items comprising cat picture slideshows in a portion of a stream of content. For convenience, ratios of one or more content types, content sources, and/or content topics to a total number of content items displayed in a portion of a content stream are referred to as a density (e.g., density of one or more content types, sources, and/or topics). In one embodiment, click propensity may be used, at least in part, to estimate a density of content types, sources, and/or topics for a user and/or a group of users (e.g., for at least a portion of a content stream). Alternative approaches are also contemplated for estimating density for a content type, source, and/or topic including, but not limited to, making assumptions as to density (e.g., such as based at least in part on ratios of content types selected by one or more users in one or more logs of browsing behavior), weighting of estimated densities, such as for a content item of an advertising type, etc.

In one embodiment, it may be possible to form a customized and/or personalized stream of content for a user based, at least in part, on content item positions in a content stream, an estimate of a probability of an interest correspondence (e.g., match) between a user-content item pair, and/or an estimate of a click propensity as to a content type. Embodiments in which content sources and/or content topics are taken into consideration are also contemplated.

In one embodiment, to form a stream of content, estimates of a density of one or more content types, sources, and/or topics may be estimated. For example, density may be estimated based, at least in part, on an estimate of click propensity. In one embodiment, substantially in accordance with relationship one (R. 1), approximation of user click propensity may use probability and/or statistics as to user interaction with content items to predict a user u's click behavior if an item of content type ct is placed at a position pos in a blended stream of content as

P(click|u,item,pos)=P(click|E,A,I)×P(E|pos)×P(A|fᵤ,fᵢₜₑₘ)×P(I|u,ct) R. 1

where a measure of clickability for one or more users of one or more items, and at one or more positions in a stream of content (e.g., click propensity) is divided into several parts. In R. 1, P(click|E, A, I) refers to an estimation of selection (e.g., click) by a user based on random variables, here, Bernoulli random variables. The terms of R. 1 are addressed item-by-item, below.

In R. 1, P(E|pos) refers to an estimate of a probability that user u will select an item were it to be placed at a position of pos in a stream. For a blended stream of content, P(E|pos) may be estimated by one or more empirical values using statistics for different positions in a blended stream of content. See, e.g., Ramakrishnan Srikant et al., User Browsing Models: Relevance versus Examination, KDD '10, Jul. 25-28, 2010 (discussing methods of using statistics to estimate a probability prediction that a user will select an item at a given position). In one embodiment, a user may be represented by an n-dimensional vector of features (e.g., a feature space representation), where features refer to, for example, but without limitation, content items selected as stored in a log of browsing behavior.

P(A|fᵤ, fᵢₜₑₘ) in R. 1 refers to an estimate of a probability of interest correspondence (e.g., matching) of a user-item pair in so-called feature space, which may be determined using, at least in part, approximation of CTR. In an embodiment, an approximation may be based at least partly on relatively large numbers (e.g., millions) of user-item pairs (e.g., items interacted with by a user), such as from one or more logs of browsing behavior. It is noted that claimed subject matter is not restricted to any particular technique of reducing logs of browsing behavior to derive preferences for a particular user. Example resources in terms of user behavior prediction, such as in the field of Internet searches, by way of example, include Haibin Cheng and Erick Cantu-Paz, Personalized Click Prediction in Sponsored Search, WSDM '10, Feb. 4-6, 2010, which discusses methods of customizing or personalizing advertisement ranking, filtering, and/or placement.

In R. 1, P(I|u, ct) refers to an adjustment factor that may be useful to at least partially account for user bias (such as differences between users based, at least in part, on browsing logs that do not depend on content).

In one embodiment, a click propensity score (e.g., P(click|u, item, pos)) may be determined for users and content type pairs using the above relation (R. 1). In this embodiment, for P(click|E, A, I), click=true occurs if E, A, and I, which, in this embodiment, refer to Bernoulli random variables, are true (e.g., whether an item is clicked at a position pos, a user-item pair correspondence exists for one or more users, a user u selects a content item of type et, etc.). For simplicity, assuming click=true, R. 1 may be rewritten:

P(click=true|u,item,pos)=P(E=true|pos)×P(A=true|fᵤ,fᵢₜₑₘ)×P(I=true|u,ct) R. 2

One consideration in estimating a click propensity (e.g., estimating a probability that a user will select a content item, such as consistent with R. 1 and R. 2) includes selection of a timeframe or window of time over which indications of browsing behavior are selected (or to be selected). For example, if indications of browsing behavior are selected covering a relatively small window of time, it may be possible that available indications of browsing behavior may not accurately represent user interests and/or preferences. For instance, spikes in browsing behavior, such as related to a noteworthy current event (e.g., natural disaster, plane crash, scandal, etc.), may skew click propensity determinations if insufficient indications of browsing behavior (e.g., not statistically significant) are present in a selected sample of browsing behavior. Therefore, to increase the potential to accumulate meaningful statistics, for example, in one implementation, indications of browsing behavior may be selected over a relatively large window of time. Different appropriate windows of time to use in selecting indications of browsing behavior may vary by situation and may include one or more days, one or more weeks, one or more months, one or more years, etc. In one embodiment, a window of time may comprise a period of time spanning all or substantially all of a time frame for which indications of browsing behavior are recorded for a given user. In another embodiment, a window of time of approximately four weeks may be used. In one embodiment, it may be desirable to vary windows of time based at least partially on context including, but not limited to, a time of day, holidays, etc. For instance, user views of content items potentially and, potentially, user preferences therefore, may vary at night time versus day time, on holiday, etc.

In one embodiment, a relatively large window of time may be used to approximate user click propensity in conjunction with existing CTR prediction techniques. For instance, some state of the art CTR prediction techniques may be built using browsing behavior of millions of users, and may be used to further refine click propensity estimation, such as for individual users. In one embodiment, a technique for determining click propensity may be based, at least in part, on estimated predictions of user browsing behavior, discussed in more detail below.

In one embodiment, it may be possible to estimate a user click propensity (“UCP”) term, UCP_{u,ct}, (e.g., P(click=true|u,item,pos) of R. 2) substantially in accordance with a likelihood function for all click/non-click events of u on a specific content type ct (noted as C_{u,ct}), for example. To illustrate, as an example, a position bias term may be assumed to be a constant value at positions of a stream of content, and pCTR_{u,item} may be logged for a user-item pair at serving time, respectively, substantially in accordance with the following:

UCP_{u,ct}=argmax_{UCP}_{_{u,ct}}P(C_{u,ct}|UCP_{u,ct}) R. 3

where

$$P ( {C}_{u , ct} \vert {UCP}_{u , ct} ) = {\prod }_{y ∈ {C}_{u , ct}} {( {Bias}_{pos} \times {pCTR}_{u , item} \times {UCP}_{u , ct} )}^{y} {( 1 - {Bias}_{pos} \times {pCTR}_{u , item} \times {UCP}_{u , ct} )}^{1 - y}$$

However, if users typically click a few times a day, on average, as mentioned, there may not be sufficient indications of browsing behavior stored for user-content type pairs for reasonable estimations.

In one embodiment, it may be possible to at least partially address sparsity by using discriminative statistics (e.g., discriminative or conditional statistics) for estimating UCP_{u,ct}. In one case, this may be accomplished by predicting UCP_{u,ct} via a set of features so as to generalize click propensity approximation in feature space as follows:

UCP_{u,ct}=P(I=true|u,ct)=P(I=true|X) R. 4

where X comprises a feature vector that corresponds to u and ct.

The following table is provided by way of example to illustrate potential features that may be used to approximate click propensity.

TABLE 1

| Feature Categories | Example of Features |
|---|---|
| Browsing behavior | {user_id} × {Video, Article, Ad} × |
| over large window | {CLICK, EC, COEC} |
| of time | |
| Demographic browsing | {AGE, GENDER, LOC} × {Video, Article, |
| behavior | Ad} × {CLICK, EC, COEC} |
| Profile Feature | SPORTS_CLICK_SCORE, |
| | ART_ENTTMT_CLICK_SCORE |

Indications of browsing behavior, such as may be stored in a log of browsing behavior, may be used to estimate statistical features based at least partially on historical click behaviors, capable of being represented in multiple dimensions. In Table 1, {user_id} refers to any useful form of user identifier, be it in the form of a formal user name for a user on a website, an IP address, an identifier assigned in a cookie, etc. {Video, Article, Ad} above refers to different example content types. {CLICK, EC, COEC} above refers to possible measures or indications of browsing behavior. In this implementation, ‘CLICK’ refers to an absolute amount of clicks of a content item, ‘EC’ refers to an expectation that a user will click on a content item, and COEC refers to a normalized historic CTR (e.g., “clicks over expected clicks”). Thus, in one example, “user_id×Video×COEC” refers to “the normalized historical CTR on videos for a user_id.” Similarly, demographic-related features, such as age, gender, and/or location, among other things, may be used, at least in part, to approximate click propensity.

It is to be understood that any number of possible features may be used in addition to or as an alternative to those in Table 1. For example, features such as those that may be associated with a user profile, may be used in at least some cases. By way of non-limiting example, features may indicate a user preference as to content topics. In one case, a feature may indicate a user preference as to content related to sports (e.g., SPORTS_CLICK_SCORE). In another case, a feature may indicate a user preference as to content related to arts and entertainment (e.g., ART_ENTTMT_CLICK_SCORE). It may be that in some embodiments, features indicating a user preference as to content topics may comprise reliable indicators of click propensity.

In one embodiment, use of n-dimension vectors to represent user browsing behavior may be usable for a machine learning-type approximation P(I=true|X; θ)=f (X; θ), where θ comprises a parameter of the approximation to be derived. A parameter θ may be estimated using a square loss function, for instance, as follows:

$$θ = arg {min}_{θ} {\sum }_{{y}_{l} ∈ C} {( {y}_{i} - {Bias}_{pos} \times {pCTR}_{u , item} \times f ( {X}_{i} ; θ ) )}^{2} = arg {min}_{θ} {\sum }_{{y}_{i} ∈ C} {w}_{i} \cdot {( \frac{{y}_{i}}{{Bias}_{pos} \times {pCTR}_{u , item}} - f ( {X}_{i} ; θ ) )}^{2} \qquad R . 5$$

where wᵢ=(Biasₚₒₛ×pCTR_{u,item})², refers to a weight of training sample i.

There may be any number of ways of taking content type into account in approximating click propensity. In one embodiment, it may be possible to use content type as one or more raw features of an approximation scheme that, for consistency, is referred to as a “unified” scheme (e.g., approach) hereinafter, where a unified scheme proposes a single model to estimate separate components of a click propensity estimation. Rather than estimating separate components together, in another embodiment, it may be possible to establish independent approximation schemes (e.g., approaches) for respective content types. Independent approximation approaches may offer flexibility over a unified approach, but may use more resources, etc. Of course, any number of other methods or schemes for approximating click propensity, such as state of the art approaches to estimate probability, are contemplated by claimed subject matter. The foregoing is presented by way of example only. In fact, any number of machine learning approaches (e.g., f (X; θ)), such as Gradient Boosted Decision Trees (GBDT), Logistical Regression (LR), Support Vector Machine (SVM), etc. could be used in an approximation process. Similarly, any one or more features may be selected to approximate click propensity. As mentioned above, it may be of particular interest to select an approximation scheme and/or features believed to improve estimates of click preferences of a user over a relatively large window of time and as to one or more different content types.

After a click propensity has been estimated, it may be used at least in part to estimate a density for one or more content types for a stream of content. In the following, a CTR of a blended stream of content may be estimated based, at least in part, on a scheme employing a first order approximation (e.g., density) with respect to different content types.

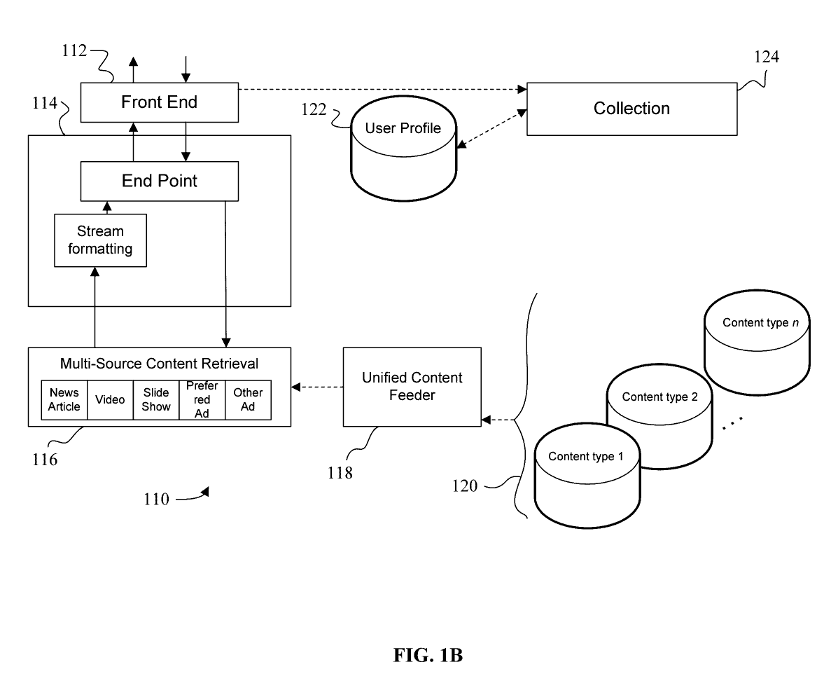

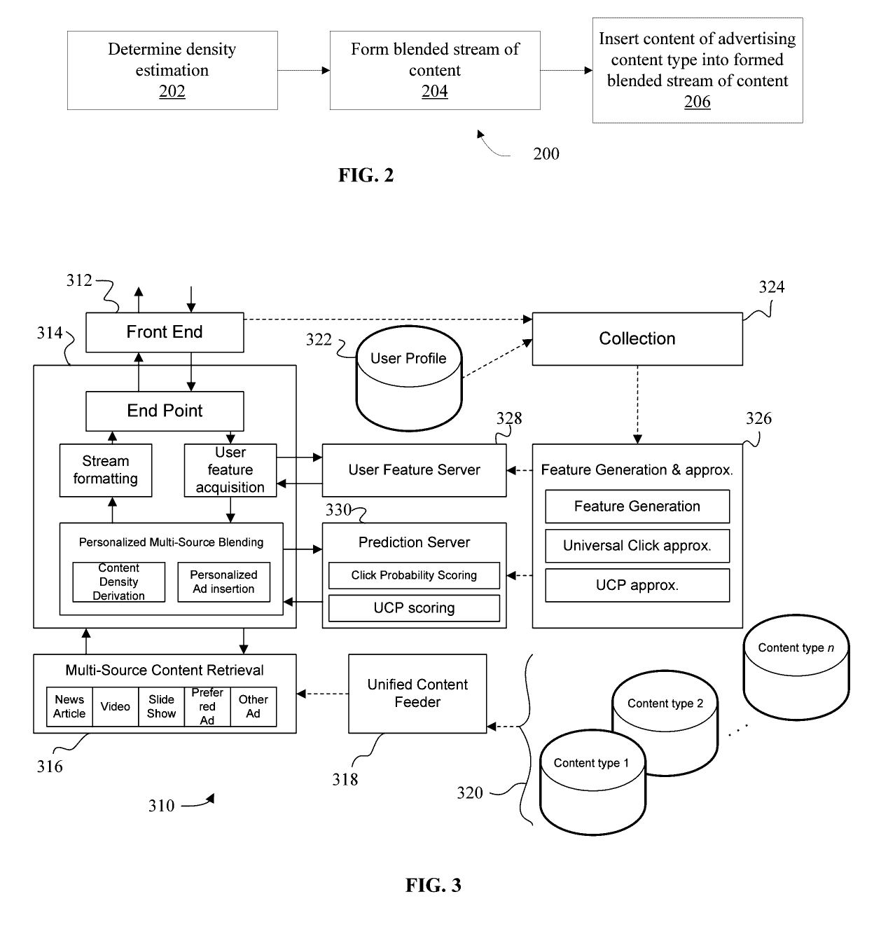

In the following paragraphs, sample illustrative methods of forming a stream of content by blending content items from one or more content types into a stream of content and inserting advertising content items into the formed blended stream are presented. It is to be understood, however, that these are provided by way of illustration only and are not meant to limit application of claimed subject matter to one or more of the following embodiments. The following discussion refers to FIGS. 2 and 3; FIG. 2 illustrates a method embodiment 200 for forming a stream of content, while FIG. 3 illustrates system embodiment 310, for use, at least in part, in forming a stream of content items.

In one embodiment, by accessing a webpage via a client device, for example, a user may access a front end 312, which may collect and/or store indications of browsing behavior (e.g., via collection component 324, which may facilitate estimation of user click propensity, click preferences, and/or feature generation (e.g., for placing one or more signals associated with a user in feature space), and/or user profile 322) to be used in forming a stream of content. A blending component 314, may be capable of, among other things, estimating a density for one or more content types. For example, in an embodiment, a system, such as system 310, may comprise a feature generation and/or approximation component 326, a user feature server component 328, and/or a prediction server component 330, as shall be described in more detail, by way of example.

For instance, referring to block 202 of FIG. 2, in one embodiment, a density estimation for non-advertising content type (e.g. news article, slideshow, video, etc.) for a user may be determined. Based, at least in part, on a density estimation, a blended stream of content may be formed comprising content items of non-advertising content types, as illustrated by block 204. Referring back to FIG. 3, formation of a stream of content that blends content items of multiple content types, sources, and/or topics, may be accomplished by a personalized multi-source blending component of blending component 314. In one implementation, requests may be made to a multi-source content retrieval component 316 based, at least in part, on a density estimation, and responsive to the requests, content items may be retrieved, such as from one or more repositories 320 via a content feeder component 318, for example.

In one implementation, content items of an advertising content type may be inserted into a formed blended stream, as illustrated by block 206 of FIG. 2. Referring back to FIG. 3, which illustrates a system embodiment 310 for forming a stream of content items; for example, at a high level, in one embodiment, a personalized multi-source blending component of blending component 314 may blend advertising type content and non-advertising type content. For example, a personalized ad insertion component may be capable of inserting one or more content items of advertising content type, into a stream of non-advertising content. A stream of content that may be passed to a stream formatting component to be formatted, such as for capability to be displayed on a user device, as illustrated by FIG. 3, for example.

More detailed discussion of components of system 310 of FIG. 3, such as in terms of example operations, is provided below. For example, in one embodiment, formation of a blended stream of content, such as illustrated by method embodiment 200, may comprise one or more portions of the following illustrative discussion. In one embodiment, it may be assumed that A₁, . . . , Aₘ refer to m non-advertising content types and B₁, . . . , Bₙ refer to n advertising content types, given a user u. It may be possible to derive an estimated density d_{u,i} (e.g., an estimated density for user u) for non-advertising content types Aᵢ, form a blended stream of content based at least in part on the estimated density d_{u,i} of user u, and then insert content items of advertising content types B₁, . . . , Bₙ into the formed blended stream.

As noted above, at block 202 of method embodiment 200, a determination may be made of a density estimation of content items of non-advertising content types for a user u. In one example, a density estimation may be determined by performing processing, such as signal processing and/or other types of processing (such as prediction, estimation, residual error feedback, etc.), on a density estimation for a content type, source, and/or topic. In one implementation, for instance, parameters may be selected to achieve a desired click through rate (CTR) of a blended stream of content substantially in accordance with estimates for achieving a desired CTR from processing of browsing logs, for example. In another implementation, parameters may be selected to achieve a desired advertising revenue, as determined by appropriate processing estimates. In still another implementation, parameters may be selected to achieve a desired dwell time for an item of content. Etc.

Other considerations to forming a stream in this manner include, but are not limited to: 1) intrinsic considerations e.g. ∀u:Σᵢ₌₁^{m}, d_{u,i}=1; 2) stream design considerations such as, by way of illustrative example, “off-network articles cannot have a density greater than approximately 20% in a particular blended stream of content”, and/or 3) implementation considerations such as, by way of non-limiting example, “video density should not exceed 40% for a particular blended stream of content”. Additional stream design considerations might also include, but are not limited to, a ratio of in-network content to off-network content, a number of advertising content items, and/or a number of videos in the formed blended stream, by way of non-limiting example.

As such, in one embodiment, density estimation of content items from multiple sources may be formulated substantially in accordance with the following

$$arg {max}_{{d}_{u , i}} {\sum }_{u ∈ All Users} {\sum }_{i = 1}^{m} {d}_{u , i} \times {UCP}_{u , i} \\ s . t . \\ {\sum }_{i = 1}^{m} {d}_{u , i} = 1 \\ {l}_{i} \leq {d}_{u , i} \leq {u}_{i} \\ {L}_{i} \leq {\sum }_{u ∈ All Users} {d}_{u , i} \leq {U}_{i} \\ {\sum }_{i = 1}^{m} {\underline{BW}}_{i} \times {d}_{u , i} \leq {τ}_{BW} \\ {\sum }_{u ∈ All Users} {\sum }_{i = 1}^{m} {\underline{BW}}_{i} \times {d}_{u , i} \leq {T}_{BW} \qquad R . 6$$

where lᵢ and uᵢ comprise density lower-bounds and upper-bounds, respectively, of type Aᵢ for a single blended stream, and Lᵢ and Uᵢ comprise density lower-bounds and upper-bounds, respectively, of type Aᵢ for a website and/or platform as a whole, where a website and/or platform “as a whole” comprises one for that website or platform a plurality of streams of content. The BWᵢ in R. 6 comprises an average bandwidth consumption of type Aᵢ, and τ_{BW} and T_{BW} represent bandwidth upper-bounds for single blended stream and an overall website and/or platform, respectively.

Although computing a value for d_{u,i}s substantially in accordance with R. 6 may present computational challenges in some cases, in general, existing linear programming methods may be employed. Any number of resources exist describing such approaches and need not be discussed in further detail. See, e.g., DAVID G. LUENBERGER, INTRODUCTION TO LINEAR AND NONLINEAR PROGRAMMING (Addison-Wesley 1973).

At block 204 of method embodiment 200, after density estimations have been determined, a blended stream of content with content items may be formed from multiple sources. Formation of a blended stream of content may comprise use of one or more density estimations as to content types (e.g., Aᵢ). In one case, formation of a blended stream of content may take into account positioning and/or placement considerations. For example, placement of certain content types (e.g., videos and advertisements) may have a tendency to alter user engagement. For example, for certain users, placement of content items of a video content type at a certain position (e.g., towards a bottom) of a portion of a blended stream of content may act to encourage user engagement (e.g., the user may scroll down to additional portions of a blended stream of content after having viewed a video type content item). Similar considerations may be taken into account for advertisements, slideshows, news articles, and other content types, by way of non-limiting example.

Thus, in at least some implementations, forming a blended stream of content may yield a stream of content partially or completely filled with content items. A blended stream of content may take any one of many potential forms. For instance, it may comprise a list of links to content items. In other cases, it may comprise a partially formed content stream formed using syntax (e.g., HTML, XML, etc.) at least partially ready to be transmitted to a user. Etc.

Advertisements in a blended stream may potentially have a negative impact on user experience and/or user engagement. As such, formation of a blended stream of content and insertion of advertisements into the formed blended stream may comprise balancing a variety of considerations, such as revenue considerations (e.g., the inclusion of advertisements), user experience considerations, etc. As such, insertion of advertising content items into a blended non-advertising stream derived at block 204 may be in accordance with a variety of possible implementations. In one implementation, for example, for positions pos in a formed blended stream, there may be a determinable position threshold Φ(pos) such that advertising content items are inserted if an estimated cost (e.g., personalized commercial value) of advertising content type surpasses a position threshold. For a user, for example, a personalized commercial value may be determined for different advertising content types so that an advertising content item may be inserted into a position in a formed blended stream if a determined personalized commercial value for a type of advertising content item is determined to be greater than a threshold associated with the position.

In one embodiment, for example, content items of an advertising type may be inserted into a blended stream of content as follows. Given a user u and the n advertising content types B₁, . . . , Bₙ, at positions pos from the top first position in the blended stream, advertising content types may be ranked in descending order based, at least in part, on the following relation:

eCPM_{u,ad,pos}=P(click=true|u,ad,pos)×bid_{ad}

where P(click|u,ad,pos)=Biasₚₒₛ×pCTR_{u,ad}×UCP_{u,j}. In this example, eCPM_{u,ad,pos} refers to an expected cost per thousand impressions (e.g., estimated cost or personalized commercial value) if ad is slotted in pos in user u's blended stream, and ad comprises an advertising content of type Bⱼ. Then, for content of advertising content types in this ranked list, a determination may be made, in a top down fashion, to find a position in the formed blended stream that, in an embodiment, meets the following comparison, so that relevant content items may be inserted into determined positions in a blended stream of content.

eCPM_{u,ad,pos}≧Φ(pos)

In one embodiment, Φ decreases monotonically as a position index increases (e.g., as a user descends (e.g., scrolls) further down a blended stream of content). As such, in some cases, care may be taken in placing content items of advertising content types at positions that are near a top of a blended stream of content. Given a specific position pos, Φ(pos) may be employed to facilitate coordination between user experience (e.g., user engagement) and revenue in an embodiment.

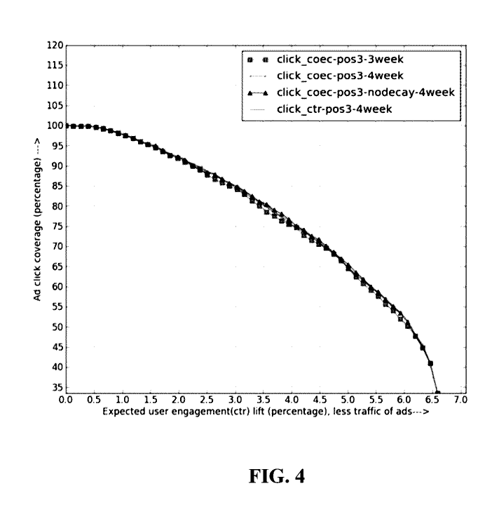

FIG. 4 is a plot of a curve for a content item of an advertising content type at position 3 (from the top) in a blended stream of content, for example. The curve of FIG. 4 is plotted over an x-axis representing user engagement and a y-axis representing revenue (in terms of a percentage of advertisements clicked). FIG. 4 demonstrates that in at least some situations a relatively uniform tradeoff between engagement and revenue may exist at a given position (e.g., position 3) in a blended stream of content. As a result, in one embodiment, for example, considerations or “guardrails” may be provided (e.g., loss of revenue not to exceed 5%) for revenue from business. In some cases, desired levels of user engagement lift (e.g., increases in user engagement) may be achieved by selecting Φ(pos) around guardrail points.

Thus, selection of Φ(pos) may be based, at least in part, on stream design considerations, such as the foregoing, by way of non-limiting example. It is noted that the foregoing is provided for illustrative purposes only. Indeed, in one implementation, as prediction of CTRs increases (e.g., pCTR), an expected cost per thousand impressions (eCPM) may take into account pCTR to greater degrees and Φ(pos) guardrails may be adjusted accordingly.

Hereinafter, two implementation examples are discussed again, solely for illustrative purposes.

In a first implementation, a click propensity is approximated and content items from multiple sources are combined to form a personalized blending of advertisements into a stream of content. In a control blended stream of content, advertisements are slotted into the blended stream of content in front of most content items (e.g., articles and multimedia contents) independent of user preferences. Placing advertisements without taking user preferences into account and/or placing advertisements in front of most content items might be expected to result in a negative impact on user engagement (e.g., as measured by CTR in the stream). An impact on user engagement may be expected to be particularly pronounced for users who have a low click propensity as to advertisements.

In the first implementation, approximation of user click propensity is used to form a stream of content, including placement of content items of advertisement types, to potentially reduce negative impact as to user engagement while potentially maintaining or improving desired levels of advertising revenue. To measure the effect that taking user click propensity into account might have, a user click propensity as to advertisements, a predicted CTR (pCTR) for advertisements, and position bias factor (e.g., Biasₚₒₛ) are used to calculate an expected cost per thousand impressions (eCPM) for the advertisements used. In this implementation, advertisements are inserted into the highest position (e.g., from a top of a content stream) where the eCPM is higher than the advertising threshold, as previously discussed. It is predicted that users with higher click propensity as to advertisements (e.g., a user with comparatively high potential to click advertisements) should have more advertisements at higher positions in respective blended stream of content.

As illustrated by the results in Table 2, the results of this approach indicate improvement over traditional methods of forming a stream of content (e.g., as compared to the control blended stream of content). By way of non-limiting example, Table 2 refers to a dwell time for a user at different depths of a content stream (e.g., a distance from a top or a first content item in a content stream), and the first implementation shows a 1.36% improvement over typical approaches. That is, as shown by implementation 1, content streams formed substantially in accordance with claimed subject matter may yield streams of content on which users may dwell longer (e.g., increased user engagement and/or potentially increased advertising revenue) than typical approaches. By way of further example, Table 2 refers to a measure of clicks per depth, which also shows an improvement, thus indicating that content streams formed substantially in accordance with claimed subject matter may yield a higher probability of user clicks at different depths of a content stream than typical approaches. Table 2 also refers to a measure of click through rate (CTR) for advertisements, and shows a relatively significant improvement (2.87%) in CTR for advertisements for a content stream formed substantially in accordance with claimed subject matter. Finally, Table 2 also refers to a measure of cost per thousand ads (CPM), and indicates a relatively substantial improvement in revenue per one thousand ads.

TABLE 2

| Stream Dwell | Stream Click | | |
|---|---|---|---|
| per depth | per depth | Ads CTR | Ads CPM |
| +1.36% | +0.41% | +2.87% | +5.1% |

In a second implementation of click propensity approximation used to determine placement of video contents in a blended stream of content. Content items of a video content type is of increasing importance in streams of content and, generally speaking, has a good monetization value compared to other content types. Some web platforms may use a static approach in placing videos into a stream of content (e.g., a video every 6, 8, 12, 16, etc. items in a blended stream). Alternatively, placement of videos may be randomized. Because not every user likes or dislikes video content, static methods of placement of videos in a blended stream of content may not maintain or raise user engagement and/or may not maintain or raise advertising revenue.

Based, at least in part, on several browsing behavior considerations, in at least some cases, the CTR may drop with monotonic increases in density of video contents, and users with at least one click on video contents may have a higher CTR on video than on articles. Thus, in an implementation, users are separated using click propensity as to content items of a video content type for investigative purposes. Specifically, users are placed in one of two groups: video-heavy and video-light. For video-heavy users, video is inserted every 8 slots, while for those video-light users, video is inserted every 32 slots. As measured, however, this results in a roughly neutral number of total video impressions, indicating that an increased number of video impressions in the video-heavy group is roughly counterbalanced by a decreased numbers of video impressions to the video-light group. This suggests that even with video content using increased amounts of bandwidth for video-heavy users, bandwidth is nevertheless not likely a technical concern (e.g., for a provider of content, to the extent that bandwidth amounts for the video-heavy group are offset by decreased bandwidth in the video-light group). Table 3 shows significant lift in both video CTR and play count.

TABLE 3

| | Stream dwell | | |
|---|---|---|---|
| Stream CTR | per uu | Video CTR | Video Playcount |
| −0.27% | +0.25% | +7.97% | +10.47% |

Indeed, while the approach of the second implementation shows roughly neutral stream CTR and stream dwell, it shows relatively significant increases in both video CTR (e.g., a measure of a rate at which video are clicked) and video playcount (e.g., a measure of a number of videos played). That is, streams formed consistently with claimed subject matter will yield substantial increases in both CTR of video-type content items and playcount of video-type content items. As shown, therefore, these increases in user engagement may be achieved while keeping overall metrics and/or overall video impressions approximately neutral.

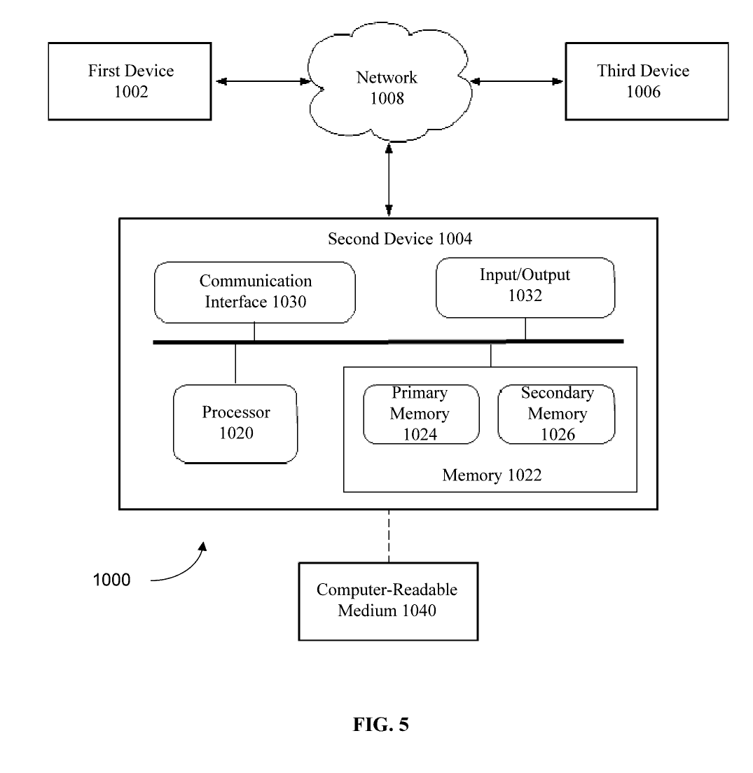

For purposes of illustration, FIG. 5 is an illustration of an embodiment of a system 100 that may be employed in a client-server type interaction, such as described below in connection with rendering a GUI via a device, such as a network device and/or a computing device, for example. In FIG. 5, computing device 1002 (‘first device’ in figure) may interface with client 1004 (‘second device’ in figure), which may comprise features of a client computing device, for example. Communications interface 1030, processor (e.g., processing unit) 1020, and memory 1022, which may comprise primary memory 1024 and secondary memory 1026, may communicate by way of a communication bus, for example. In FIG. 5, client computing device 1002 may represent one or more sources of analog, uncompressed digital, lossless compressed digital, and/or lossy compressed digital formats for content of various types, such as video, imaging, text, audio, etc. in the form physical states and/or signals, for example. Client computing device 1002 may communicate with computing device 1004 by way of a connection, such as an internet connection, via network 1008, for example. Although computing device 1004 of FIG. 5 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processor 1020 may be representative of one or more circuits, such as digital circuits, to perform at least a portion of a computing procedure and/or process, such as, for example, those discussed above in relation to FIGS. 2 and 3. By way of example, but not limitation, processor 1020 may comprise one or more processors, such as controllers, microprocessors, microcontrollers, application specific integrated circuits, digital signal processors, programmable logic devices, field programmable gate arrays, the like, or any combination thereof. In implementations, processor 1020 may perform signal processing to manipulate signals and/or states, to construct signals and/or states, etc., for example.

Memory 1022 may be representative of any storage mechanism. Memory 1020 may comprise, for example, primary memory 1022 and secondary memory 1026, additional memory circuits, mechanisms, or combinations thereof may be used. Memory 1020 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 1020 may be utilized to store a program. Memory 1020 may also comprise a memory controller for accessing computer readable-medium 1040 that may carry and/or make accessible content, which may include code, and/or instructions, for example, executable by processor 1020 and/or some other unit, such as a controller and/or processor, capable of executing instructions, for example, such as related to functionality for forming a stream of content.

Under direction of processor 1020, memory, such as memory cells storing physical states, representing, for example, a program, may be executed by processor 1020 and generated signals may be transmitted via the Internet, for example. Processor 1020 may also receive digitally-encoded signals from client computing device 1002.

Network 1008 may comprise one or more network communication links, processes, services, applications and/or resources to support exchanging communication signals between a client computing device, such as 1002, and computing device 1006 (‘third device’ in figure), which may, for example, comprise one or more servers (not shown). By way of example, but not limitation, network 1008 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 1004, as depicted in FIG. 5, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 1022 may store cookies relating to one or more users and may also comprise a computer-readable medium that may carry and/or make accessible content, including code and/or instructions, for example, executable by processor 1020 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra wideband (UWB), 802.11b/g/n, and/or the like. A wireless network may include virtually any type of now known and/or to be developed wireless communication mechanism by which signals may be communicated between devices, between networks, within a network, and/or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, Mac OS X, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets and/or frames, such as in a network of participating digital communications. A broadcast domain may be compliant and/or compatible with, but is not limited to, now known and/or to be developed versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

One skilled in the art will recognize that a virtually unlimited number of variations to the above descriptions are possible, and that the examples and the accompanying figures are merely to illustrate one or more particular implementations for illustrative purposes. They are not therefore intended to be understood restrictively.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method of blending content items of multiple content types with advertising content items in a blended stream of content items, the blended stream of content items to be streamed to a particular user, the method comprising:
forming for the particular user the blended stream of content items of the multiple content types based, at least in part, on one or more density estimates of content type for at least one of the multiple content types; and
inserting, in the formed blended stream, advertising content items so as to maintain or increase user engagement.

2. The method of claim 1, wherein the one or more density estimates are approximated based at least in part on a user click propensity.

3. The method of claim 2, wherein the user click propensity is based at least in part on a determination of a probability of a corresponding user-item pair in user feature space.

4. The method of claim 2, wherein the user click propensity is based at least in part on one or more indications of user browsing behavior over a large window of time.

5. The method of claim 1, wherein the one or more density estimates are approximated based at least in part on one or more stream design considerations.

6. The method of claim 5, wherein the one or more stream design considerations comprise at least one of: a ratio of in-network content to off-network content, a number of advertising content items, or a number of videos in the formed blended stream.

7. The method of claim 6, wherein the one or more stream design considerations comprise limiting off-network content to less than approximately 20% of the formed blended stream, limiting density of content types with video to less than or equal to approximately 40% for the formed blended stream, or a combination thereof.

8. The method of claim 1, wherein inserting advertising content items comprises:
determining a position threshold for a plurality of positions of a portion of the formed blended stream of content;
determining an estimated cost to insert a first one of the advertising content items at the plurality of positions; and
inserting the first one of the advertising content items at a position of the plurality of positions of the formed blended stream of content in response to a determination that the determined estimated cost exceeds the determined position threshold.

9. The method of claim 8, wherein determining the estimated cost comprises determining an expected cost per thousand impressions (eCPM) based, at least in part, on a user click propensity, a predicted click through rate (pCTR), and a position bias factor.

10. An system comprising:
a computing device; the computing device to:
form, for a particular user, a blended stream of content items of multiple content types based, at least in part, on one or more density estimates of content type for at least one of the multiple content types; and
insert, in the formed blended stream, one or more advertising content items so as to maintain or increase user engagement.

11. The system of claim 10, wherein the one or more density estimates are to be approximated based at least in part on a user click propensity.

12. The system of claim 11, wherein the user click propensity is to be based at least in part on a determination of a probability of a corresponding user-item pair in user feature space.

13. The system of claim 11, wherein the user click propensity is to be based at least in part on one or more indications of user browsing behavior over a large window of time.

14. The system of claim 10, wherein the one or more density estimates are to be approximated based at least in part on one or more stream design considerations.

15. The system of claim 14, wherein the one or more stream design considerations comprise at least one of: a ratio of in-network content to off-network content, a number of advertising content items, or a number of videos in the formed blended stream.

16. The system of claim 10, wherein insertion of advertising content items is to:
determine a position threshold for a plurality of positions of a portion of the formed blended stream of content;
determine an estimated cost to insert a first one of the advertising content items at the plurality of positions; and
insert the first one of the advertising content items at a first of the plurality of positions of the formed blended stream of content in response to a determination that the determined estimated cost exceeds the determined position threshold.

17. A system comprising:
means for forming, for a particular user, a blended stream of content items of multiple content types based, at least in part, on one or more density estimates of content type for at least one of the multiple content types; and
means for inserting, in the formed blended stream, one or more advertising content items so as to maintain or increase user engagement.

18. The system of claim 17, further comprising means for approximating the one or more density estimates based at least in part on a user click propensity based at least in part on one or more indications of user browsing behavior over a large window of time.

19. The system of claim 17, further comprising:
means for determining a position threshold for a plurality of positions of a portion of the formed blended stream of content;
means for determining an estimated cost to insert a first one of the advertising content items at the plurality of positions; and
means for inserting the first one of the advertising content items at a position of the plurality of positions of the formed blended stream of content in response to a determination that the determined estimated cost exceeds the determined position threshold.

20. The system of claim 19, wherein the means for determining the estimated cost further comprises means for determining an expected cost per thousand impressions (eCPM) based, at least in part, on a user click propensity, a predicted click through rate (pCTR), and a position bias factor.
